(19) United States
(12) Patent Application Publication
(10) Pub. No.: US 2011/0269453 A1
(43) Pub. Date: Nov. 3, 2011

(54) APPARATUS AND METHOD FOR INTER-RADIO ACCESS TECHNOLOGY CARRIER AGGREGATION MOBILITY ENHANCEMENT

(75) Inventors: Karri Markus Ranta-Aho, Atlanta, GA (US); Harri Kalevi Holma, Helsinki (FI); Antti Anton Toskala, Espoo (FI)

(73) Assignee: NOKIA SIEMENS NETWORKS OY, Espoo (FI)

(21) Appl. No.: 12/912,131

(22) Filed: Oct. 26, 2010

Related U.S. Application Data
(60) Provisional application No. 61/330,699, filed on May 3, 2010.

(51) Int. Cl. H04W 24/00

(52) U.S. Cl. 455/424

(57) ABSTRACT

A method, apparatus, and computer program product are provided for inter-radio access technology carrier aggregation mobility enhancement. The apparatus receives a mobility reporting parameter from a first network node. The apparatus measures parameters of signals received from the first network node and one or more second network nodes based on the measurement reporting parameters. The apparatus generates a measurement report based on the measurement reporting parameters and the measured parameters of the signals, transmits the measurement report to the first network node, and receives a mobility parameter from the first network node based on the measurement report. The measurement reporting parameters include report configuration information for configuring the measurement report based on measured parameters obtained for designated signals received from the first network node and for signals received from the one or more second network nodes.

### CROSS REFERENCE TO RELATED APPLICATION:

The present application is related to, and claims the priority of U.S. Provisional Patent Application Ser. No. 61/330,699, filed May 3, 2010, the entirety of which is incorporated by reference.

### BACKGROUND

1. Field

Embodiments of the invention generally relate to communications networks and particularly to wireless communications networks, for example, Global System for Mobile Communications (GSM), the Universal Mobile Telecommunications System (UMTS), High Speed Packet Access (HSPA), and Evolved Universal Terrestrial Radio Access (EUTRA). More particularly, certain embodiments of the invention relate to methods, apparatuses, and computer program products for inter-radio access technology carrier aggregation mobility enhancement.

2. Description of the Related Art

In order to deliver very high data throughputs to mobile nodes, the access networks may employ carrier aggregation and mobile nodes may receive and transmit on multiple component carriers, i.e., frequency bands. Carrier aggregation affects many functionalities in mobile networks, such as the mobility of mobile nodes and measurement reporting from mobile nodes.

Connected mode mobility, as discussed, for example, in 3GPP TS 36.331 V9.2.0 (2010 April), generally relates to a network node controlling the mobility of a mobile node during a radio resource control connection. The network node determines when the mobile node shall move to another cell, i.e., to another network node, which may be operating on another frequency or radio access technology. The network node triggers a handover procedure based, for example, on radio conditions, load capacity of the other network node, etc. To facilitate the handover procedure, the network node may configure the mobile node to perform measurement reporting that may include the configuration of measurement gaps. The network node may, in some conditions, blindly initiate handover of the mobile node to the other network node.

Inter-radio access technology (Inter-RAT) carrier aggregation has been utilized to enhance the rate of data transmission from one or more network nodes, for example, a long term evolution (LTE) eNodeB, a HSPA NodeB etc., to a mobile node, for example, user equipment.

Mobility of mobile nodes and handover procedures in systems employing Inter-RAT or Intra-RAT carrier aggregation may be based on measurement reports for a first component carrier available in a first network node, for example, a LTE node. Inter-radio access technology carrier aggregation may further include a second network node, for example, a HSPA node, as an additional downlink-only carrier. Mobility management and handover procedures of the mobile node during inter-radio access technology carrier aggregation may be primarily based on measurements results for the LTE carrier, and the mobility management for data of the HSPA carrier may directly follow the mobility and handover decisions obtained for the LTE carrier.

Problems may exist, however, if the optimal handover areas for the mobile node are different for the first and second network nodes, as illustrated in FIG. 1. For example, the first and second network nodes may be operating at different frequencies (i.e., a LTE carrier operating at 1,800 or 2,600 MHz, while the HSPA carrier is operating at 2,100 MHz). In another example, the LTE carrier and the HSPA carrier may be using different antennas. In either of these two cases, the inter-radio access technology carrier aggregation will not provide the maximum data throughput to the mobile node. This may occur when the mobile node is not connected to the best serving HSPA network node that could provide the best radio link quality on the HSPA carrier between the HSPA network node and the mobile node. For example, a problem may be experienced with mobility management when the mobile node is approaching a site that provides HSPA radio access to mobile nodes, but does not provide LTE radio access to the mobile nodes. In such a case, measurement results obtained for the HSPA and LTE are uncorrelated and mobility and handover decisions for the HSPA carrier cannot be inferred from mobility and handover decisions for the LTE carrier. In such a case, the resulting total data rate is low as HSPA data is coming from another cell rather than the cell with the best link budget, and the LTE cell is also at a cell edge providing a low data rate.

Current inter-radio access technology carrier aggregation only involves the LTE carrier, and therefore measurement reporting is provided only for the LTE carrier. Inter-systems measurements are used when initiated by the system. Current inter-radio access technology carrier aggregation does not take into consideration measurement reporting for the other carriers, for example, the HSPA carrier.

### SUMMARY

In accordance with an embodiment of the invention, there is provided an apparatus. The apparatus includes at least one processor, and at least one memory including computer program code. The at least one memory and the computer program code are configured to, with the at least one processor, cause the apparatus at least to receive a measurement reporting parameter from a first network node. The apparatus generates a measurement report based on the measurement reporting parameters and the one or more measured parameters of the signals received from the first network node and measured parameters received from the one or more second network nodes. The apparatus transmits the measurement report to the first network node, and receives a network mobility parameter from the first network node based on the measurement report. The measurement reporting parameters include report configuration information for configuring the measurement report based on the one or more measured parameters obtained for at least one designated signal received from the first network node and parameters obtained for signals from the one or more second network nodes.

In accordance with an embodiment of the invention, there is provided a method. The method includes receiving, using a receiver, a measurement reporting parameter from a first network node. The method further includes measuring, using a processor, one or more parameters of signals received from a first network node and one or more second network nodes based on the measurement reporting parameter and generating a measurement report based on the one or more parameters. The method further includes generating, using the processor, a measurement report based on the measurement reporting parameters and the one or more measured parameters of the signals received from the first network node and the one or more parameters obtained for signals received from the one or more second network nodes. Further, the method includes transmitting, using a transmitter, the measurement report to the first network node, and receiving, using the receiver, a network mobility parameter from the first network node based on the measurement report. The measurement reporting parameters include report configuration information for configuring the measurement report based on the one or more measured parameters obtained for at least one designated signal received from the first network node and one or more parameters obtained for signals received from the one or more second network nodes.

In accordance with an embodiment of the invention, there is provided another apparatus. The apparatus includes at least one processor, and at least one memory including computer program code. The at least one memory and the computer program code are configured to, with the at least one processor, cause the apparatus at least to transmit measurement reporting parameters to a mobile node. The apparatus receives a measurement report, based on the measurement reporting parameters, from the mobile node, wherein the measurement report comprises one or more parameters of signals received in the mobile node. Further, the apparatus transmits a network mobility parameter to the mobile node based on the measurement report. The measurement reporting parameters include report configuration information for configuring the measurement report based on the one or more parameters obtained in the mobile node for at least one designated signal received from the apparatus and parameters obtained for signals received from one or more other network nodes, i.e. signals not received from the apparatus.

In accordance with an embodiment of the invention, there is provided another method. The method includes transmitting, using a transmitter, a measurement reporting parameter from a first network node to a mobile node. The method further includes receiving, in the first network node, using a receiver, a measurement report from the mobile node. Based on the measurement reporting parameters, the measurement report includes one or more parameters of signals received in the mobile node from the first network node and parameters obtained for signals received from one or more second network nodes. The method further includes transmitting, using the transmitter, a network mobility parameter to the mobile node based on the measurement report. The measurement reporting parameters includes report configuration information for configuring the measurement report based on the one or more parameters obtained in the mobile node for at least one designated signal received from the first network node and parameters obtained for signals received from the one or more second network nodes.

In accordance with an embodiment of the invention, there is provided a computer program product which may be executed in a mobile node and which is embodied on a computer readable storage medium. The computer program product is encoded with instructions to control a processor to perform a process. The process includes receiving, using a receiver, a measurement reporting parameter from a first network node. The process further includes measuring, using a processor, one or more parameters of signals received from the first network node and parameters of signals received from one or more second network nodes based on the measurement reporting parameters and generating a measurement report based on the one or more parameters. The process further includes generating, using the processor, a measurement report based on the measurement reporting parameters and the one or more measured parameters of the signals received from the first network node and parameters obtained for signals received from the one or more second network nodes. Further, the process includes transmitting, using a transmitter, the measurement report to the first network node, and receiving, using the receiver, a network mobility parameter from the first network node based on the measurement report. The measurement reporting parameters include report configuration information for configuring the measurement report based on the one or more measured parameters obtained for at least one designated signal received from the first network node and parameters obtained for signals received from the one or more second network nodes.

In accordance with an embodiment of the invention, there is provided a computer program product which may be executed in a network node and which is embodied on a computer readable storage medium. The computer program product is encoded with instructions to control a processor to perform a process. The process includes transmitting, using a transmitter, a measurement reporting parameter from a first network node to a mobile node. The process further includes receiving, in the first network node, using a receiver, a measurement report from the mobile node. Based on the measurement reporting parameters, the measurement report includes one or more measured parameters of signals received in the mobile node from the first network node and parameters obtained for signals received in the mobile node from one or more second network nodes. The process further includes transmitting, using the transmitter, a network mobility parameter to the mobile node based on the measurement report. The measurement reporting parameters include report configuration information for configuring the measurement report based on the one or more parameters obtained in the mobile node for at least one designated signal received in the mobile node from the first network node and parameters obtained for signals received in the mobile node one or more second network nodes.

### BRIEF DESCRIPTION OF THE DRAWINGS

Reference will now be made in detail to the embodiments of the invention, examples of which are illustrated in the accompanying drawings.

FIG. 1 illustrates different mobility requirements of an optimal cell change for a mobile node with a long term evolution carrier and a high speed packet access carrier of a conventional wireless communication system.

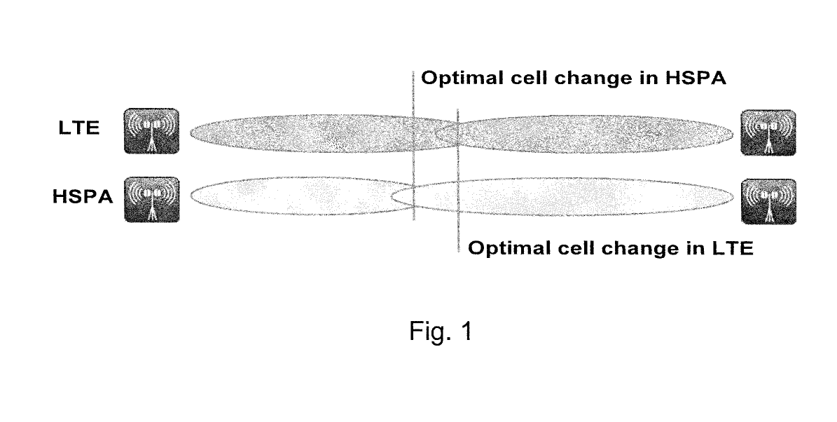

FIG. 2 illustrates measurements for inter-radio access technology carrier aggregation, in accordance with an embodiment of the invention.

FIG. 3 illustrates inter-radio access technology carrier aggregation, in accordance with another embodiment of the invention.

FIG. 4 illustrates an apparatus, in accordance with an embodiment of the invention.

FIG. 5 illustrates a method, in accordance with an embodiment of the invention.

FIG. 6 illustrates a method, in accordance with another embodiment of the invention.

FIG. 7 illustrates an apparatus, in accordance with an embodiment of the invention.

FIG. 8 illustrates a method, in accordance with an embodiment of the invention.

FIG. 9 illustrates a method, in accordance with another embodiment of the invention.

### DETAILED DESCRIPTION

It will be readily understood that the components of the invention, as generally described and illustrated in the figures herein, may be arranged and designed in a wide variety of different configurations. Thus, the following detailed description of the embodiments of the apparatus, the method, and the computer program product, as represented in the attached figures, is not intended to limit the scope of the invention as claimed, but is merely representative of selected embodiments of the invention.

For example, while the exemplary embodiments have been described above in the context of HSPA and LTE systems, it should be appreciated that the exemplary embodiments of this invention are not limited for use with this one particular combination of wireless communication systems, and that they may be used to advantage in other wireless communication systems and combinations of wireless communication systems.

If desired, the different functions discussed below may be performed in a different order and/or concurrently with each other. Furthermore, if desired, one or more of the above-described functions may be optional or may be combined. As such, the foregoing description should be considered as merely illustrative of the principles, teachings and embodiments of this invention, and not in limitation thereof

Embodiments of the invention are directed in particular to inter-RAT carrier aggregation, whereby measurement reports for the HSPA carrier are based on measurement reports obtained for the LTE carrier. According to an embodiment of the invention, when a mobile device receives a strong signal on the LTE carrier, and the transmission on the LTE carrier can sustain the necessary data rate, no measurement report for the HSPA carrier may be triggered, unless the received signal on the HSPA carrier of another cell is significantly stronger than the signal the mobile device receives on the LTE carrier.

According to another embodiment of the invention, when the mobile device receives a weak signal on the LTE carrier (i.e., only a low date rate achievable on the LTE carrier), a measurement report may be triggered when a new stronger signal on a HSPA carrier is detected.

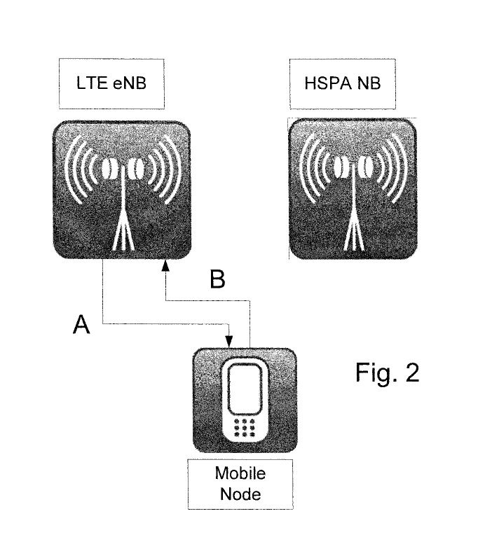

FIG. 2 illustrates measurements for inter-radio access technology carrier aggregation, in accordance with an embodiment of the invention.

As illustrated in FIG. 2, a LTE evolved Node B (LTE eNB) may transmit LTE reporting parameters (A) to the mobile node employing inter-RAT carrier aggregation. A typical reporting parameter such as handover hysteresis for LTE event A3 may be in a range of 1-3 dB. The eNB may transmit additional control parameters (A) for HSPA measurements to the mobile node. The hysteresis may be larger for the HSPA measurement reporting, for example, 3-6 dB. The objective of the settings of the inter-RAT measurement reporting is to provide information when measurement results obtained on the LTE carrier in a mobile node do trigger for inference measurement results on the HSPA carrier to be reported to the network. This may, for instance, happen when the mobile node is approaching a site with a network node which provides radio access for HSPA but not for LTE. Mobility and handover decisions based on measurement results obtained for the LTE carrier will in such a case not ensure that the mobile node is connected to the HSPA cell with the best signal quality.

As further illustrated in FIG. 2, if the trigger condition for HSPA measurement reporting is met, the mobile node may send HSPA measurement reports to the LTE eNB (B) in addition to LTE measurement reports. The LTE eNB may utilize the received HSPA measurement reports to meet mobility and handover decisions for the mobile node employing LTE/HSPA carrier aggregation to enhance the data rate of the transmission to the mobile node.

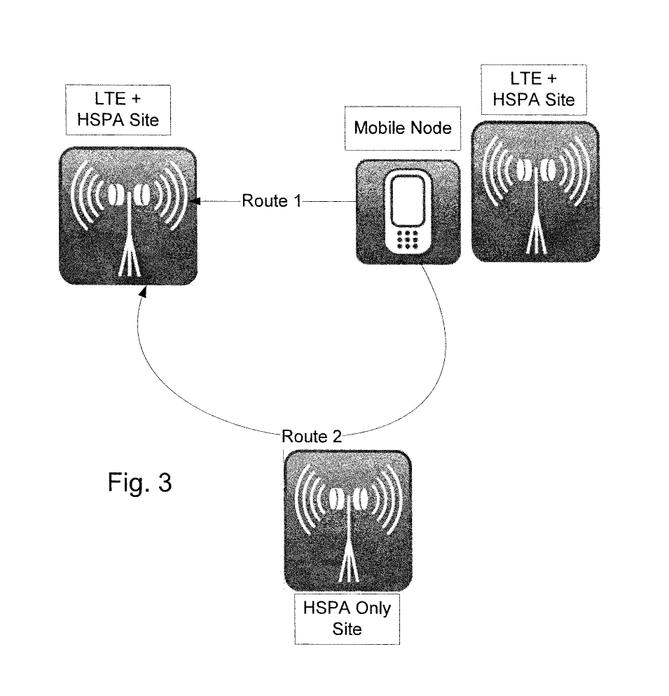

FIG. 3 illustrates inter-radio access technology carrier aggregation, in accordance with another embodiment of the invention.

As illustrated in FIG. 3, when the LTE carrier and HSPA carrier are operating in different frequencies, a mobile node employing inter-RAT carrier aggregation may, for instance, follow one of two routes.

Along the first route (Route 1), the mobile node may experience good signal quality on the LTE carrier, ensuring a sufficient data rate. Furthermore, the measurements in the mobile node along Route 1 will typically not indicate significant differences between the measurement results on the LTE and the HSPA carrier, since both sites, at the starting point and at the endpoint, provide radio access to LTE and HSPA. Therefore, no trigger condition for HSPA measurement reporting is met and the mobile node will only send measurement reports for the LTE carrier.

Along the second route (Route 2), mobility and handover decisions for the HSPA carrier may not be based on measurement reports obtained for the LTE carrier only, since the signal quality on the HSPA carrier in the proximity of the site supporting only radio access for HSPA can no longer be inferred from measurement reports obtained for the LTE carrier. Appropriate trigger conditions may be defined in such a case for HSPA measurement reporting in order to ensure that the mobile node along Route 2 is always connected to the HSPA cell providing the best signal quality or at least to a HSPA cell providing sufficient signal quality. Measurement reporting for the HSPA carrier may be triggered when the received signal on the LTE carrier is weak (i.e., allowing only a low data rate) and/or the received signal on a HSPA carrier is significantly stronger than the received signal on the LTE carrier.

In an embodiment of the invention, downlink throughput may be improved when the mobility decision can be based both on the LTE and the HSPA measurement reports. This improvement may occur when path loss values are different for different network nodes, i.e., for different base stations.

In this embodiment, the mobile node may be configured to employ carrier aggregation over at least two carriers. For example, the at least two carriers may include at least one LTE carrier and at least one HSPA carrier. A LTE carrier may be selected and may be configured to control the mobile node to measure and report parameters of the HSPA carrier(s). The criteria for HSPA measurement reporting may be based on the reference signal received power (RSRP)/reference signal received quality (RSRQ) of the selected LTE carrier. For example, the reference signal received power (RSRP)/reference signal received quality (RSRQ) of the selected LTE carrier may need to be below a predefined threshold level before the measurement reports for the HSPA carriers may be sent by the mobile node to the controlling network node (eNB) on the selected LTE carrier. The threshold may be predefined such that a reliable measurement reporting on the selected LTE carrier is still ensured.

In another scenario, the reference signal received power (RSRP)/reference signal received quality (RSRQ) of the selected LTE carrier may need to be below the common pilot channel (CPICH) received signal code power (RSCP)/common pilot channel chip energy noise level (Ec/N0) of a HSPA carrier with a predefined margin before the measurement reports for the HSPA carrier may be sent by the mobile node to the controlling network node (eNB) on the selected LTE carrier.

In accordance with another embodiment of the invention, there is employed LTE carrier aggregation. In this embodiment, the mobile node may be configured to aggregate at least two LTE carriers. A first LTE carrier may be selected and may be configured to control the mobile node to measure and report parameters of at least one second LTE carrier. The criteria for measurement reporting on the at least one second LTE carrier may be based on the reference signal received power (RSRP)/reference signal received quality (RSRQ) of the first LTE carrier. For example, the reference signal received power (RSRP)/reference signal received quality (RSRQ) of the first LTE carrier may need to be below a threshold level before the measurement reports for the at least one second LTE carrier may be sent by the mobile node to the controlling network node (eNB).

In another scenario, the reference signal received power (RSRP)/reference signal received quality (RSRQ) of the first LTE carrier may need to be below a reference signal received power (RSRP)/reference signal received quality (RSRQ) level with a set margin of at least one of the at least one second LTE carriers before the measurement reports for the at least one second LTE carrier may be sent by the mobile node to the controlling network node (eNB).

In accordance with another embodiment of the invention, there is employed HSPA carrier aggregation. In this embodiment, the mobile node may be configured to aggregate at least two HSPA carriers. A first HSPA carrier may be selected and may be configured to control the mobile node to measure and report parameters of at least one second HSPA carrier. The criteria for measurement reporting on the at least one second HSPA carrier may be based on the common pilot channel received signal code power (RSCP)/common pilot channel chip energy noise level (Ec/N0) of the first HSPA carrier. For example, the common pilot channel received signal code power (RSCP)/common pilot channel chip energy noise level (Ec/N0) of the first HSPA carrier may need to be below a threshold level before the measurement reports for the at least one second HSPA carrier may be sent by the mobile node to the controlling network node (NB).

In another scenario, common pilot channel received signal code power (RSCP)/common pilot channel chip energy noise level (Ec/N0) of the first HSPA carrier may need to be below a common pilot channel received signal code power (RSCP)/common pilot channel chip energy noise level (Ec/N0) with a set margin of at least one of the at least one HSPA carriers before the measurement reports for the at least one second HSPA carrier may be sent by the mobile node to the controlling network node (NB).

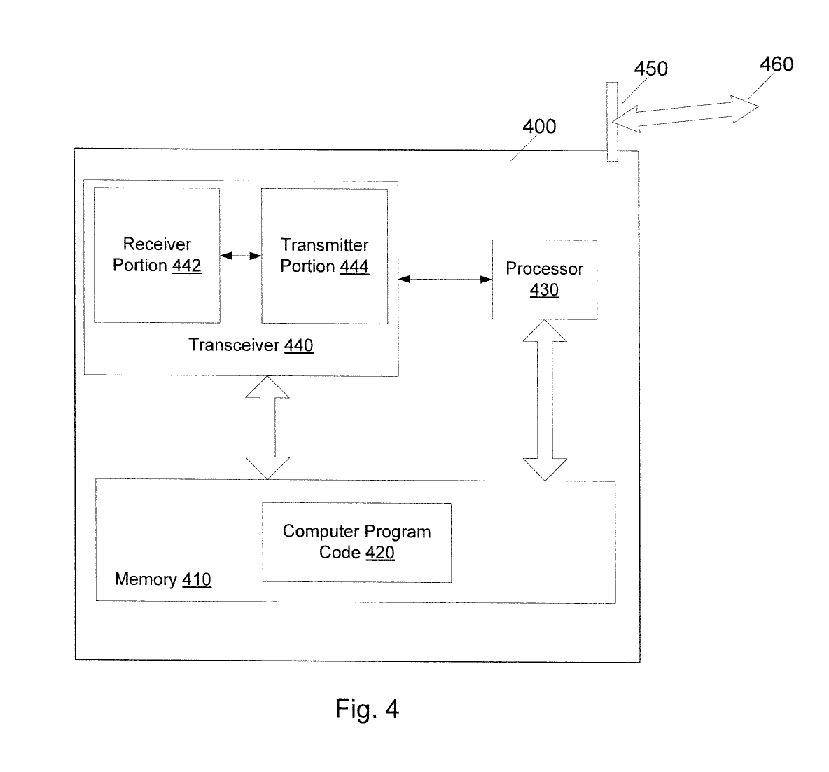

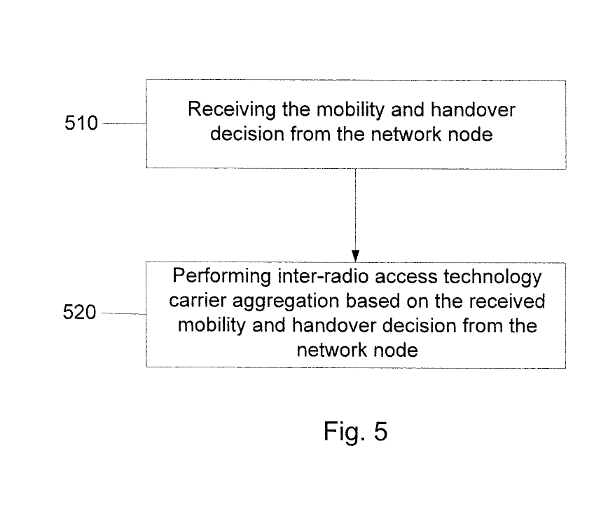

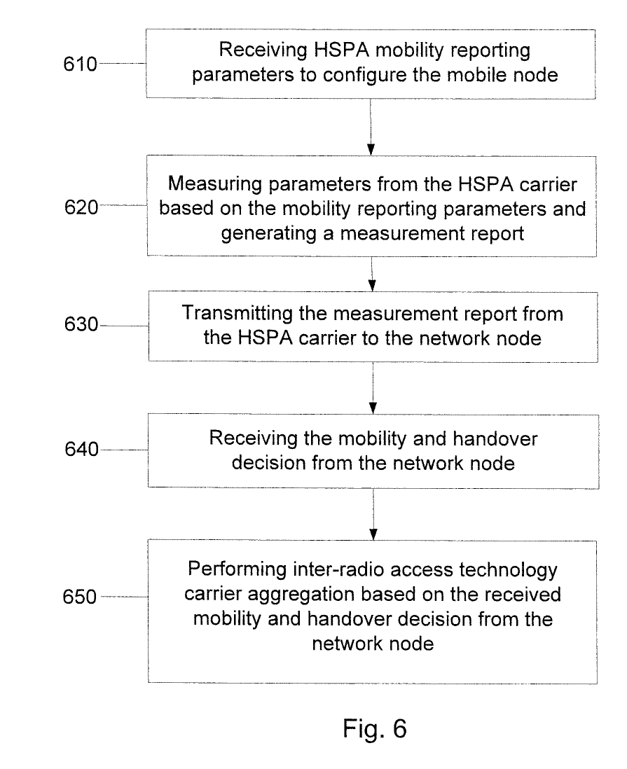

FIG. 4 illustrates an apparatus, in accordance with certain embodiments of the invention. The apparatus 400 may include, for example, a mobile node or user equipment. The apparatus 400 may include a memory 410 including computer program code 420. The computer program code 420 may be embodied on a computer readable non-transitory medium. The apparatus 400 may also include a processor 430 for processing information and executing instructions or operations. The memory 410 may be coupled to the processor 430 for storing information and instructions to be executed by the processor 430. The computer program code 420 may be encoded with instructions to control the processor 430 to perform the method discussed below and illustrated in FIGS. 5 and 6.

While a single memory 410 and a single processor 430 are illustrated in FIG. 4, multiple memory and multiple processors may be utilized according to other embodiments.

Further, the apparatus 400 may be configured to communicate, using a transceiver 440 having a receiver portion 442 and a transmitter portion 444, with a network node, for example, a base station, an evolved node B, or a high speed downlink packet access node (not illustrated). The apparatus 400 may further include an antenna 450 to communicate with the network node over a wireless link 460, which may be a cellular radio link, for example, an inter-radio access technology link.

In accordance with certain embodiments of the invention, the receiver portion 442 may be configured to receive, via the antenna 450 over the wireless link 460, a mobility and handover decision from a network node. The network node may include, for example, a LTE evolved node B carrier. The processor 430 may be configured to perform inter-radio access technology carrier aggregation based on the received mobility and handover decision from the network node.

When a strong LTE signal is present, the receiver portion 442 may be configured to receive the mobility and handover decision from the network node. A measurement report from a HSPA carrier may not be triggered, unless a received signal on a HSPA carrier of another cell is significantly stronger than the signal the apparatus 400 receives from the network node. Therefore, the processor 430 may be configured to perform inter-radio access technology carrier aggregation based solely on the mobility and handover decision from the network node based on measurement reports for the LTE signal.

However, when a HSPA signal from another network node, for example, a HSPA carrier, is significantly stronger than the LTE signal or when a weak LTE signal is present (i.e., only a low date rate is achievable on the LTE carrier), the receiver portion 442 may be configured to receive HSPA measurement reporting parameters to configure the apparatus 400 for measuring and reporting parameters of the HSPA carrier. The processor portion 430 may be configured to measure one or more measurement parameters from the HSPA carrier based on the measurement reporting parameters and to generate a measurement report of the one or more measurement parameters to be utilized for the inter-radio access technology carrier aggregation. The transmitter portion 444 may be configured to transmit, via the antenna 450 over the wireless link 460, the measurement report from the HSPA carrier to the network node to be used for determining the mobility and handover decision of the network node. The receiver portion 442 may be configured to receive the mobility and handover decision from the network node. The processor 430 may be configured to perform inter-radio access technology carrier aggregation based on the mobility and handover decision from the network node.

In accordance with certain embodiments of the invention, the processor 430 may be configured to perform inter-radio access technology carrier aggregation of at least two carriers. The at least two carriers may include one of (1) at least one LTE carrier and at least one HSPA carrier, (2) at least two LTE carrier, and (3) at least two LTE high speed downlink packet access carriers, as discussed above.

FIG. 5 illustrates a method, in accordance with an embodiment of the invention. When a strong LTE signal is present, the method may include receiving, via the receiver portion 442, a mobility and handover decision from the network node (step 510). A measurement report from a HSPA carrier may not be triggered, because the LTE carrier can sustain the needed data rate of the transmission. The method may further include performing, using the processor 430, inter-radio access technology carrier aggregation based solely on the received mobility and handover decision from the network node based on measurement reports for the LTE signal (step 520).

FIG. 6 illustrates a method, in accordance with an embodiment of the invention. When a HSPA signal from another network node, for example, a HSPA carrier, is significantly stronger than the LTE signal or when a weak LTE signal is present (i.e., only a low date rate is achievable on the LTE carrier), the method may include receiving HSPA measurement reporting parameters from the network node to configure the apparatus 400 for measuring and reporting parameters of the HSPA carrier (step 610). The method may further include measuring, using the processor 430, one or more measurement parameters from the HSPA carrier based on the measurement reporting parameters and generating a measurement report of the one or more measurement parameters to be utilized for the inter-radio access technology carrier aggregation (step 620). The method may include transmitting, via the transmitter portion 444, the measurement report from the HSPA carrier to the network node to be used for determining the mobility and handover decision of the network node (step 630). The method may include receiving, via the receiver portion 442, the mobility and handover decision from the network node (step 640). The method may include performing inter-radio access technology carrier aggregation based on the mobility and handover decision received from the network node based on measurement reports for the LTE signal (step 650).

In accordance with certain embodiments of the invention, the method may include performing inter-radio access technology carrier aggregation of at least two carriers. The at least two carriers may include one of (1) at least one LTE carrier and at least one HSPA carrier, (2) at least two LTE carriers, and (3) at least two HSPA carriers, as discussed above.

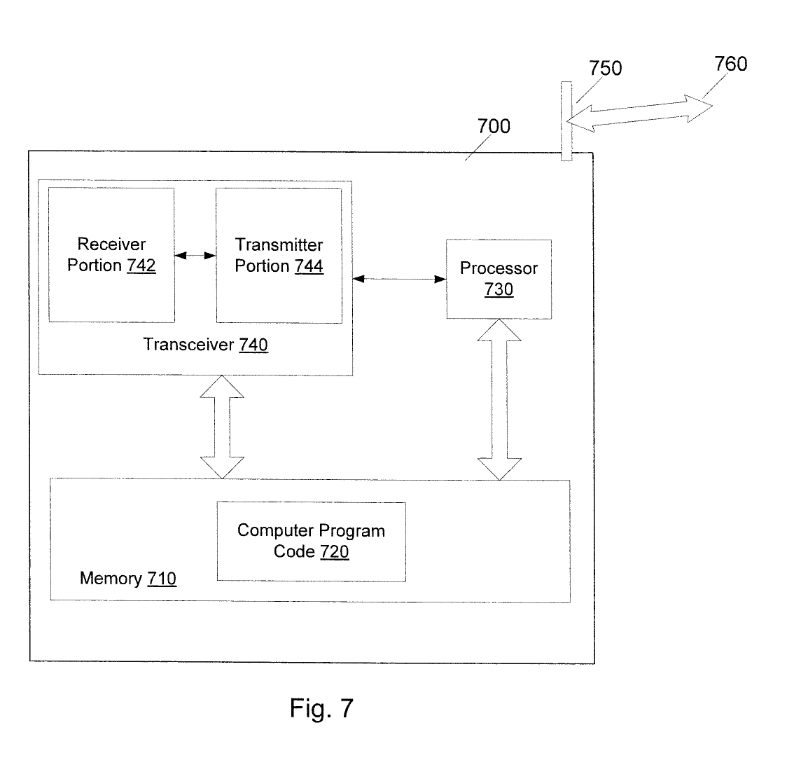

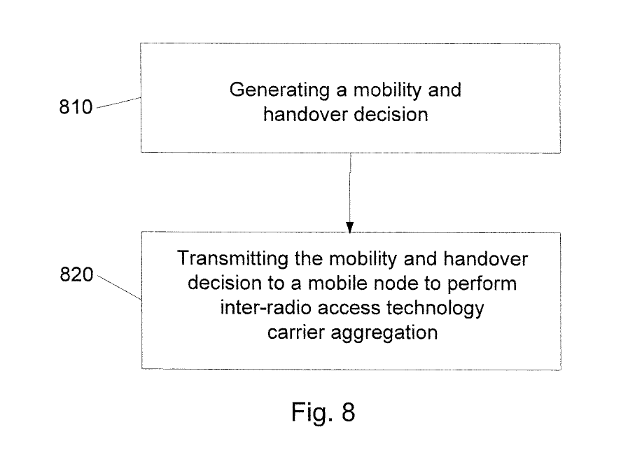

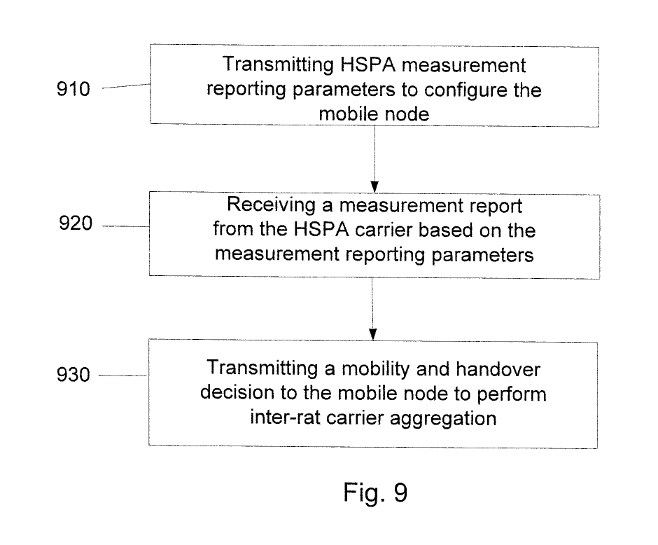

FIG. 7 illustrates an apparatus, in accordance with certain embodiments of the invention. The apparatus 700 may include, for example, a network node, for example, a LTE evolved node B. The apparatus 700 may include a memory 710 including computer program code 720. The computer program code 720 may be embodied on a computer readable non-transitory medium. The apparatus 700 may also include a processor 730 for processing information and executing instructions or operations. The memory 710 may be coupled to the processor 730 for storing information and instructions to be executed by the processor 730. The computer program code 720 may be encoded with instructions to control the processor 730 to perform the method discussed below and illustrated in FIGS. 8 and 9.

While a single memory 710 and a single processor 730 are illustrated in FIG. 7, multiple memory and multiple processors may be utilized according to other embodiments.

Further, the apparatus 700 may be configured to communicate, using a transceiver 740 having a receiver portion 742 and a transmitter portion 744, with a mobile node, for example, user equipment (not illustrated). The apparatus 700 may further include an antenna 750 to communicate with the network node over a wireless link 760, which may be a cellular radio link, for example, an inter-radio access technology link.

In accordance with certain embodiments of the invention, when a strong LTE signal is present, the transmitter portion 744 may be configured to transmit a mobility and handover decision to the mobile node. A measurement report from a HSPA carrier may not be triggered, because the apparatus 700 may be configured to sustain the needed data rate of the transmission. Therefore, inter-radio access technology carrier aggregation may be based solely on the received mobility and handover decision from the apparatus 700 based on measurement reports for the LTE signal.

However, when a HSPA signal from another network node, for example, a HSPA carrier, is significantly stronger than the LTE signal or when a weak LTE signal is present (i.e., only a low date rate is achievable on the LTE carrier), the transmitter portion 744 may be configured to transmit HSPA measurement reporting parameters to configure the mobile node for measuring and reporting parameters of the HSPA carrier. The receiver portion 742 may be configured to receive, via the antenna 750 over the wireless link 760, a measurement report from the HSPA carrier through the mobile node to be used for determining the mobility and handover decision of the apparatus 700. The transmitter portion 744 may be configured to transmit the mobility and handover decision from the apparatus 700 to the mobile node, whereby the mobile node performs inter-radio access technology carrier aggregation based on the mobility and handover decision from the apparatus 700.

In accordance with certain embodiments of the invention, inter-radio access technology carrier aggregation may be performed on at least two carriers. The at least two carriers may include one of (1) at least one LTE carrier and at least one HSPA carrier, (2) at least two LTE carrier, and (3) at least two LTE high speed downlink packet access carriers, as discussed above.

FIG. 8 illustrates a method, in accordance with an embodiment of the invention. When a strong LTE signal is present, the method may include generating a mobility and handover decision (step 810). The method may further include transmitting, via the transmitter portion 742, the mobility and handover decision from the apparatus 700 to the mobile node for performing inter-radio access technology carrier aggregation (step 820). A measurement report from a HSPA carrier may not be triggered, because the apparatus 700 can sustain the needed data rate of the transmission. Therefore, inter-radio access technology carrier aggregation may be performed based solely on the transmitted mobility and handover decision from the apparatus 700 based on measurement reports for the LTE signal.

FIG. 9 illustrates a method, in accordance with another embodiment of the invention. When a HSPA signal from another network node, for example, a HSPA carrier, is significantly stronger than the LTE signal or when a weak LTE signal is present (i.e., only a low date rate is achievable on the LTE carrier), the method may include transmitting, using the transmitter portion 744, HSPA measurement reporting parameters to configure the mobile node for measuring and reporting parameters of the HSPA carrier (step 910). The method may further include receiving, via the receiver portion 742, a measurement report from the HSPA carrier through the mobile node to be used for determining the mobility and handover decision of the apparatus 700 (step 920). The measurement report may include one or more parameters from the HSPA carrier that are based on the measurement reporting parameters. The method may include transmitting, via the transmitter portion 744, the mobility and handover decision from the apparatus 700 to the mobile node, whereby the mobile node performs inter-radio access technology carrier aggregation based on the mobility and handover decision from the apparatus 700 (step 930).

In accordance with certain embodiments of the invention, inter-radio access technology carrier aggregation may be performed on at least two carriers. The at least two carriers may include one of (1) at least one LTE carrier and at least one HSPA carrier, (2) at least two LTE carrier, and (3) at least two LTE high speed downlink packet access carriers, as discussed above.

Further to the discussion above, it is to be understood that in an embodiment of the invention, the steps and the like may be changed without departing from the spirit and scope of the present invention. In addition, the methods described in FIGS. 5, 6, 8 and 9 may be repeated numerous times.

The memory 410, 710 may be of any type suitable to the local technical environment and may be implemented using any suitable data storage technology, machine or computer readable storage medium, such as semiconductor-based memory devices, flash memory, magnetic memory devices and systems, optical memory devices and systems, fixed memory and removable memory, as non-limiting examples. The processors 430, 730 may be of any type suitable to the local technical environment, and may include one or more of general purpose computers, special purpose computers, microprocessors, digital signal processors (DSPs), and processors based on multi-core processor architecture, as non-limiting examples.

A computer program code 420, 720 according to certain embodiments of the invention, may be composed of modules that are in operative communication with one another, and which are designed to pass information or instructions to a communication device, such as the mobile node or the user equipment, a personal computer, a handheld device, such as a mobile, a cellular telephone, or a personal digital assistant (PDA) having wireless communication capabilities, a portable computer having wireless communication capabilities, an image capture device, such as a digital camera having wireless communication capabilities, a gaming device having wireless communication capabilities, a music storage and playback appliance having wireless communication capabilities, an Internet appliance permitting wireless Internet access and browsing, as well as a portable unit or a terminal that incorporates combinations of such functions.

The computer program code 420, 720 may be configured to operate on a general purpose computer or an application specific integrated circuit (ASIC).

The computer readable non-transitory medium may include any media or means that can contain, store, communicate, propagate or transport the instructions for use by or in connection with an instruction execution system, apparatus, or device, for example, a disk media, computer memory, or other storage device. Non-transitory storage medium does not include a transitory signal. Examples of non-transitory storage medium include, for example, a computer-readable medium, a computer distribution medium, a computer-readable storage medium, and a computer program product.

The embodiments of the invention discussed above may be implemented by hardware, computer software executable by one or more of the processors 430, 730 of the apparatus 400 and the apparatus 700, respectively, or by a combination of hardware and software.

The software and/or hardware may reside on apparatus 400, apparatus 700, or other mobile communication devices. If desired, part of the software and/or hardware may reside on a apparatus 400, part of the software and/or hardware may reside on a apparatus 700, and part of the software and/or hardware may reside on other mobile communication devices. In an embodiment of the invention, software, or an instruction set may be maintained on any one of various conventional computer-readable media.

In accordance with an embodiment of the invention, there is provided a computer program product embodied on a computer readable storage medium. The computer program product is encoded with instructions to control a processor to perform a process. The process includes transmitting, using a transmitter, a mobility reporting parameter to a mobile node, and receiving, using a receiver, a measurement report from the mobile node. The measurement report includes one or more parameters of a network node that are based on the mobility reporting parameter. The process further includes transmitting, using the transmitter, a mobility parameter to the mobile node based on the measurement report.

One having ordinary skill in the art will readily understand that the invention as discussed above may be practiced with steps in a different order, and/or with hardware elements in configurations which are different than those which are disclosed. Therefore, although the invention has been described based upon these preferred and non-limiting embodiments, it would be apparent to those of skill in the art that certain modifications, variations, and alternative constructions would be apparent, while remaining in the spirit and scope of the invention. Thus, the example embodiments do not limit the invention to the particular listed devices and technologies. In order to determine the metes and bounds of the invention, therefore, reference should be made to the appended claims.

We claim:

1. An apparatus, comprising:
at least one memory including computer program code; and
at least one processor,
wherein the at least one memory and the computer program code are configured to, with the at least one processor, cause the apparatus at least to
receive measurement reporting parameters from a first network node,
measure one or more parameters of signals received from the first network node and one or more second network nodes based on the measurement reporting parameters,
generate a measurement report based on the measurement reporting parameters and the one or more measured parameters of the signals received from the first network node and the one or more second network nodes,
transmit the measurement report to the first network node, and
receive a network mobility parameter from the first network node based on the measurement report,
wherein the measurement reporting parameters comprise report configuration information for configuring the measurement report based on the one or more measured parameters obtained for at least one designated signal received from the first network node and measured parameters obtained for signals received from one or more second network nodes.

2. The apparatus of claim 1, wherein the at least one memory and the computer program code are configured to, with the at least one processor, cause the apparatus at least to measure the one or more parameters of the received signals, wherein the one or more measured parameters comprise a received signal quality of a composite carrier.

3. The apparatus of claim 1, wherein each of the first network node and the one or more second network nodes comprises one of a long term evolution evolved access node and a high speed packet access node.

4. The apparatus of claim 1, wherein the at least one memory and the computer program code are configured to, with the at least one processor, cause the apparatus at least to
receive the measurement reporting parameters comprising signal quality measures and set margins for differences between the one or more measured parameters obtained for the at least one designated signal received from the first network node and measured parameters obtained for signals received from the one or more second network nodes,
measure, when the set margin for at least one measured parameter is exceeded,
include in the measurement report one or more obtained parameters for at least one signal from the one or more second network nodes when the set margin for at least one obtained parameter is exceeded, and
transmit the measurement report to the first network node.

5. The apparatus of claim 1, wherein the at least one memory and the computer program code are configured to, with the at least one processor, cause the apparatus at least to
receive the measurement reporting parameters comprising signal quality measures and threshold levels for signal quality of the at least one designated signal,
measure, when the signal quality for at least one designated signal falls below a received threshold level,
include in the measurement report one or more obtained parameters for at least one signal from the one or more second network nodes when the measured signal quality for at least one designated signal falls below a received threshold level, and transmit the measurement report to the first network node.

6. The apparatus of claim 4, wherein the at least one memory and the computer program code are configured to, with the at least one processor, cause the apparatus at least to receive the measurement reporting parameters comprising the signal quality measures, wherein a signal quality measure comprises at least one of reference signal received power, reference signal received quality, common pilot channel received signal code power, and common pilot channel chip energy noise level.

7. The apparatus of claim 5, wherein the at least one memory and the computer program code are configured to, with the at least one processor, cause the apparatus at least to receive the measurement reporting parameters comprising the signal quality measures, wherein a signal quality measure comprises at least one of reference signal received power, reference signal received quality, common pilot channel received signal code power, and common pilot channel chip energy noise level.

8. A method, comprising:
receiving, using a receiver, measurement reporting parameters from a first network node;
measuring, using a processor, one or more parameters of signals received from a first network node and one or more second network nodes based on the measurement reporting parameters,
generating, using the processor, a measurement report based on the measurement reporting parameters and the one or more measured parameters of the signals received from the first network node and the one or more second network nodes;
transmitting, using a transmitter, the measurement report to the first network node; and
receiving, using the receiver, a network mobility parameter from the first network node based on the measurement report,
wherein the measurement reporting parameters comprise report configuration information for configuring the measurement report based on the one or more parameters obtained for at least one designated signal received from the first network node and parameters obtained for signals received from the one or more second network nodes.

9. The method of claim 8, wherein the measuring the one or more parameters comprises measuring the one or more parameters of the received signals comprising a received signal quality of a composite carrier.

10. The method of claim 8, wherein the receiving the measurement reporting parameters comprises receiving signal quality measures and set margins for differences between the one or more measured parameters obtained for the at least one designated signal received from the first network node and measured parameters obtained for signals received from the one or more second network nodes,
wherein the measuring the one or more parameters comprises measuring, when the set margin for at least one measured parameter is exceeded, and
wherein the generating a measurement report comprises including in the report one or more obtained parameters for at least one signal from the one or more second network nodes when the set margin for at least one measured parameter is exceeded.

11. The method of claim 8, wherein the receiving the measurement reporting parameters comprises receiving signal quality measures and threshold levels for a signal quality of the at least one designated signal,
wherein the measuring the one or more parameters comprises measuring, when the signal quality for at least on of the designated signals falls below a received threshold level, and
wherein the generating a measurement report comprises including in the report one or more obtained parameters for at least one signal from the one or more second network nodes when the signal quality for at least one of the designated signals falls below a received threshold level.

12. The method of claim of 10, wherein the receiving the signal quality measures comprises receiving a signal quality measure comprising at least one of reference signal received power, reference signal received quality, common pilot channel received signal code power, and common pilot channel chip energy noise level.

13. The method of claim of 11, wherein the receiving the signal quality measures comprises receiving a signal quality measure comprising at least one of reference signal received power, reference signal received quality, common pilot channel received signal code power, and common pilot channel chip energy noise level.

14. An apparatus, comprising:
at least one memory including computer program code; and
at least one processor,
wherein the at least one memory and the computer program code are configured to, with the at least one processor, cause the apparatus at least to
transmit measurement reporting parameters to a mobile node,
receive a measurement report, based on the measurement reporting parameters, from the mobile node, wherein the measurement report comprises parameters of signals received in the mobile node, and
transmit a network mobility parameter to the mobile node based on the measurement report,
wherein the measurement reporting parameters comprise report configuration information for configuring the measurement report based on the one or more parameters obtained in the mobile node for at least one designated signal received from the apparatus and parameters obtained in the mobile node for signals received from one or more other network nodes.

15. The apparatus of claim 14, wherein the at least one memory and the computer program code are configured to, with the at least one processor, cause the apparatus at least to receive the measurement report comprising the one or more parameters of signals received in the mobile node, wherein the one or more parameters comprise a received signal quality of a composite carrier.

16. The apparatus of claim 14, wherein each of the apparatus and the one or more other network nodes comprises one of a long term evolution evolved access node and a high speed packet access node.

17. The apparatus of claim 14, wherein the at least one memory and the computer program code are configured to, with the at least one processor, cause the apparatus at least to
transmit the measurement reporting parameters comprising signal quality measures to employ in the mobile node and set margins for differences between the one or more parameters obtained for the at least one designated signal received in the mobile node from the apparatus and parameters obtained for signals received in the mobile node from one or more other network nodes, and
receive, when the set margin for at least one obtained parameter is exceeded, the measurement report from the mobile node,
wherein the measurement report comprises one or more parameters obtained for at least one signal received in the mobile node from one or more other network nodes.

18. The apparatus of claim 14, wherein the at least one memory and the computer program code are configured to, with the at least one processor, cause the apparatus at least to
transmit the measurement reporting parameters comprising signal quality measures to employ in the mobile node and threshold levels for a signal quality measure of at least one designated signal received in the mobile node from the apparatus, and
receive, when the signal quality for at least one designated signal falls below a threshold level, the measurement report from the mobile node, wherein the measurement report comprises one or more parameters obtained for at least one signal received in the mobile node from one or more other network nodes.

19. The apparatus of claim 17, wherein the at least one memory and the computer program code are configured to, with the at least one processor, cause the apparatus at least to transmit the signal quality measures, wherein a signal quality measure comprises at least one of reference signal received power, reference signal received quality, common pilot channel received signal code power, and common pilot channel chip energy noise level.

20. The apparatus of claim 18, wherein the at least one memory and the computer program code are configured to, with the at least one processor, cause the apparatus at least to transmit the signal quality measures, wherein a signal quality measure comprises at least one of reference signal received power, reference signal received quality, common pilot channel received signal code power, and common pilot channel chip energy noise level.

21. A method, comprising:
transmitting, using a transmitter, measurement reporting parameters from a first network node to a mobile node;
receiving, in the first network node, using a receiver, a measurement report from the mobile node, wherein, based on the measurement reporting parameters, the measurement report comprises one or more parameters of signals received in the mobile node from the first network node and one or more parameters of signals received in the mobile node from one or more second network nodes, and
transmitting, using the transmitter, a network mobility parameter to the mobile node based on the measurement report,
wherein the measurement reporting parameters comprise report configuration information for configuring the measurement report based on the one or more parameters obtained in the mobile node for at least one designated signal received from the first network node and the one or more parameters obtained in the mobile node for signals received from one or more second network nodes.

22. The method of claim 21, wherein the receiving the measurement report comprises receiving the measurement report comprising the one or more parameters of signals received in the mobile node, wherein the one or more parameters comprise a received signal quality of a composite carrier.

23. The method of claim 21, wherein the transmitting the measurement reporting parameters comprises sending signal quality measures to employ in the mobile node and set margins for differences between the one or more parameters obtained for at least one designated signal received in the mobile node from the first network node and parameters obtained for signals received in the mobile node from one or more second network nodes, and
wherein the receiving the measurement report comprises receiving, when the set margin for at least one parameter is exceeded, the measurement report from the mobile node, wherein the measurement report comprises one or more parameters obtained in the mobile node for at least one signal received in the mobile node from one or more second network nodes.

24. The method of claim 21, wherein the transmitting the measurement reporting parameters comprises sending signal quality measures to employ in the mobile node and threshold levels for the signal quality of at least one designated signal received in the mobile node from the first network node, and
wherein the receiving the measurement report comprises receiving, when the signal quality for at least one designated signal falls below the threshold level, the measurement report from the mobile node, wherein the measurement report comprises one or more parameters obtained in the mobile node for at least one signal received in the mobile node from one or more second network nodes.

25. The method of claim 23, wherein the sending the signal quality measures comprises transmitting a signal quality measure comprising at least one of reference signal received power, reference signal received quality, common pilot channel received signal code power, and common pilot channel chip energy noise level.

26. The method of claim 24, wherein the sending the signal quality measures comprises transmitting a signal quality measure comprising at least one of reference signal received power, reference signal received quality, common pilot channel received signal code power, and common pilot channel chip energy noise level.

27. A computer program product embodied on a computer readable storage medium, the computer program product being encoded with instructions to control a processor to perform a process, the process comprising:
receiving, using a receiver, measurement reporting parameters from a first network node;
measuring, using a processor, one or more parameters of signals received from the first network node and parameters of signals received from one or more second network nodes based on the measurement reporting parameters,
generating, using the processor, a measurement report based on the measurement reporting parameters and the one or more measured parameters of the signals received from the first network node and the parameters obtained for signals received from the one or more second network nodes;
transmitting, using a transmitter, the measurement report to the first network node; and
receiving, using the receiver, a network mobility parameter from the first network node based on the measurement report
wherein the measurement reporting parameters comprise report configuration information for configuring the measurement report based on the one or more measured parameters obtained for at least one designated signal received from the first network node and one or more measured parameters for signals received from the one or more second network nodes.

28. A computer program product embodied on a computer readable storage medium, the computer program product being encoded with instructions to control a processor to perform a process, the process comprising:
transmitting, using a transmitter, measurement reporting parameters from a first network node to a mobile node;
receiving, in the first network node, using a receiver, a measurement report from the mobile node,
wherein, based on the measurement reporting parameters, the measurement report comprises one or more measured parameters of signals received in the mobile node from the first network node and one or more measured parameters of signals received in the mobile node from one or more second network nodes, and
transmitting, using the transmitter, a network mobility parameter to the mobile node based on the measurement report,
wherein the measurement reporting parameters comprise report configuration information for configuring the measurement report based on the one or more parameters obtained in the mobile node for at least one designated signal received from the first network node and the one or more parameters obtained in the mobile node for signals received from one or more second network nodes.
